(19) United States
(12) Patent Application Publication
(10) Pub. No.: US 2010/0226425 A1
(43) Pub. Date: Sep. 9, 2010

(54) ENCODING AND DETECTING APPARATUS

(75) Inventors: Stephen Mark Keating, Berkshire (GB); Ian McLean, Surrey (GB); Mark Julian Russell, Berkshire (GB); Daniel Luke Hooper, Surrey (GB); Daniel Warren Tapson, London (GB)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY UNITED KINGDOM LIMITED, Weybridge (GB)

(21) Appl. No.: 12/303,338

(22) PCT Filed: May 3, 2007
(86) PCT No.: PCT/GB07/01605

§ 371 Date: Mar. 24, 2009

(30) Foreign Application Priority Data
Jun. 6, 2006 (GB) 0611127.2

(51) Int. Cl. H04N 11/02

(52) U.S. Cl. 375/240.01; 375/E07.026

(57) ABSTRACT

An encoding data processor generates a video material item marked copy by representing a payload data word as a code word and embedding the code word into a copy of the video material item. A preprocessor divides the payload word into plural parts, forms plural initial values from the plural parts, each initial value formed by adding parts of the payload data word to each initial value successively starting with the first part added to the first initial value, and adds the first and second to the second initial value so each subsequent initial value includes all parts of the payload data word of the previous initial values and a new part of the payload data word. An encryption processor receives each initial value and generates an encrypted data stream using a payload encryption key. A combiner combines the encrypted payload data word with the video material item.

### FIELD OF INVENTION

The present invention relates to encoding data processing apparatus and methods for generating marked copies of material items by introducing a payload data word into copies of the material items.

Correspondingly, the present invention also relates to detecting data processing apparatus and methods operable to detect code words, which may be present in marked material items.

The present invention also relates to media terminals for generating marked copies of material items for reproduction. In some applications, the material items may be video material items, and the media terminal may form part of a digital cinema projector.

### BACKGROUND OF THE INVENTION

Generally, a technique for embedding data in material to the effect that the embedded data is perceptible or imperceptible is referred to as watermarking. Code words are applied to copies of material items for the purpose of identifying the copy of the material item or for conveying data represented by the code words. In some applications, watermarking can provide, therefore, a facility for identifying a recipient of a particular copy of the material.

A process in which information is embedded in material for the purpose of identifying a specific copy of the material is referred to as finger printing. A code word, which identifies the material, is combined with the material in such a way that, as far as possible, the code word is imperceptible in the material. As such, if the material is copied or used in a way, which is inconsistent with the wishes of the owner, distributor or other rights holder of the material, the copy of the material can be identified from the code word, so that the right holder can take appropriate action. The code word is therefore used to convey a payload data word, which can be used to identify uniquely the copy of the material. In the following description and claims, the term “water mark” and “finger printing” may be used interchangeably, particularly in respect of the encoding and detection techniques disclosed.

In co-pending UK patent application number 0327854.6 an encoding data processor is disclosed for application to for example digital cinema in which payload data having two or more fields is represented by watermarking an image with one or more code words. Each value of a first field of a payload data word is associated with a first code word, and each value of a second or subsequent data field is represented by a second code word, which is selected in dependence upon the value of the first data field. As such a detected code word can be used to identify one of a plurality of sub-sets into which the data words are divided, each data word in the sub-set having the same value in the first field. A second or subsequent field of the data word from the sub-set can be then identified by detecting a second code word from the material item. The second code word identifies a value in the second data field as well as the value of the first data field.

The first and second fields can be assigned to different associated parameters such as for example address parameters. The first field could therefore identify the country of distribution of the material, whereas the second field could identify a particular distribution outlet within the country. A watermarking or finger printing system can be formed for identifying a point of distribution of copies of video material.

UK patent application number 0424225.1 discloses an apparatus and method for embedding a payload data word into video images for application to digital cinema. The payload data word includes a data field providing a representation of a date and time of reproduction of the video images, and a data field providing a representation of an identifying codeword of the projector.

Generally, it is desirable to reduce a likelihood of an embedded code word being detectable. If a code word is detected, the payload data word may be determined. As a result the watermarking system could be compromised by attackers wishing to remove a code word or include a false code word to disrupt detection of the payload data.

### SUMMARY OF INVENTION

According to the present invention there is provided an encoding data processing apparatus for generating a marked copy of a material item by representing a payload data word as a code word and embedding the code word into a copy of the material item. The apparatus comprises a code word generator including a pre-processor and an encryption processor. The pre-processor is operable to divide the payload word into a plurality of parts, to form a plurality of initial values from the plurality of parts. Each of the initial values is formed by adding parts of the payload data word to each initial value successively starting with the first part added to the first initial value, and adding the first and second to the second initial value so that each subsequent initial value includes all the parts of the payload data word of those of the previous initial values in addition to a new part of the payload data word. The encryption processor is operable to receive each of the initial values and to generate an encrypted data stream from each of the initial values using a payload encryption key to provide a plurality of encrypted data streams. The combiner is operable to select parts of the encrypted data streams, and to combine the selected parts of the encrypted data streams with the frames of the material item.

Embodiments of the present invention provide an arrangement in which a payload data word can be embedded within a material item to the effect of allowing the payload data word to be recovered from the material item without an exhausting search which could otherwise be computationally prohibitive. Furthermore, the likelihood of an attacker being able to discover, alter or destroy the payload data word in the material item is reduced. To this end, a plurality of initial values are used to generate a plurality of encrypted data streams, which are substantially orthogonal or are at least arranged to provide improved orthogonality between each other when being detected by correlation. As such, the presence of one encrypted part of the payload data word is less likely to interfere with the detection of another part of the payload data word. The payload data word is divided into a plurality of parts and each of the parts is successively added to each of the plurality of initial values. Thus starting with the first initial value, the first initial value is formed from the first part of the payload data word. The second initial value is formed from the first and second parts of the payload data word, the third initial value is formed from the first, second and third parts of the payload data word and so on. Thereafter, the n-th initial value IVₙ is formed from the parts of the initial values as expressed as follows:

IVₙ=Σₗ₌₀^{l=n-1}part(n−l)

Thus each subsequent initial value is formed from a further code word part and all the previous code word parts.

In some examples, each of the initial values includes a field index providing an identification of that initial value.

The number of data symbols included in the initial values maybe set to the effect that each of the initial values provide at least some degree of orthogonality with respect to each other, when the parts of the payload data word are being detected. Each of the encrypted data streams is made substantially orthogonal with respect to one another because encryption is used to generate each of the data streams and as a result of the length of each of the data streams being sufficiently long to appear substantially “random-like”. Encrypting the data streams as part of their generation has an effect that a change of one bit in the initial value input to the encryption circuit has an effect of producing a very different encrypted data stream with respect to the encrypted stream, which would have been generated for the unaltered initial value. Furthermore, by arranging for the encrypted data streams to be sufficiently long, an encrypted data stream will correlate with itself producing a high correlation output value, with the unwanted encryption data streams producing a lower correlation value for longer encrypted streams. Thus, by setting the initial values to a predetermined length which is long enough to cause a correlation with unwanted encrypted data streams to be a substantially low value, a likelihood of successfully detecting the wanted encrypted data stream is increased.

Since the parts of the payload are divided into each of the initial values the detection of one of the parts can be used to ensure the detection of another of the parts. Thus, by detecting the first part of the of the payload data word from one or more of the initial values, subsequent parts of the payload data word can be successively detected.

Video images are one example of material, which can be protected by embedding a digital code word. Other examples of material, which can be protected by embedding a code word, include still image, audio data, software programs, digital documents (optionally reproduced on paper or other media) and any other information-bearing signal.

According to an aspect of the present invention there is provided a detecting data processing apparatus operable to detect a payload data word embedded within a marked copy of a material item by the encoding data processing apparatus. The detecting data processing apparatus comprises an initial value regenerator operable to generate each possible value of each of a plurality of parts of the payload data word, starting with the first part, to form, for each possible value of the part of the payload data word an initial value. An encryption processor is operable to receive each of the initial values and to regenerate an encrypted data stream from each of the initial values using a payload encryption key. A correlator is operable under control of the control processor to detect the part of the payload data word by correlating each of the regenerated encrypted data streams with a part of the code word, corresponding to the encrypted data stream for the regenerated initial value, recovered from the marked version of the material item, and detecting the part of the payload from a result of the correlation. The control processor is arranged to store the detected part of the payload in a data store and to use the detected part of the payload to form subsequent initial values using the detected part of the code word in combination with all possible values of a subsequent part of the payload data word and the corresponding encrypted data streams, for detecting the subsequent part of the payload.

Various further aspects and features of the present invention are defined in the appended claims.

### BRIEF DESCRIPTION OF THE DRAWINGS

Embodiments of the present invention will now be described by way of example only with reference to the accompanying drawings, where like parts are provided with corresponding reference numerals, and in which:

FIG. 1 is a schematic block diagram of an encoding data processing apparatus for combining a payload data word with a video material item to form a marked version of the video material item;

FIG. 2 is a schematic representation illustrating a formation of initial values for generating encrypted data streams for embedding in a video image using the encoding data processing apparatus shown in FIG. 1;

FIG. 3 is a schematic representation illustrating a further example of initial values for generating encrypted data streams for embedding in a video image using the encoding data processing apparatus shown in FIG. 1;

FIG. 4 is a schematic block diagram of a further example of an encoding data processing apparatus for combining a payload data word with a video material item to form a marked version of the video material item;

FIG. 5 is a schematic block diagram of a further example of an encoding data processing apparatus for combining a payload data word with a video image to form a marked version of the image;

FIG. 6 is a schematic block diagram of a payload generation processor forming part of the encoding data processing apparatus show in FIG. 5;

FIG. 7 is a schematic block diagram of a shuffle processor for generating a randomisation of the encrypted data streams which are combined with the video image by the encoding data processing apparatus of FIG. 5;

FIG. 8 is a schematic block diagram of a combining processor which forms part of the encoding data processing apparatus of FIG. 5; and

FIG. 9 is a schematic block diagram of a detecting data processing apparatus for detecting a payload data word embedded into video images.

### DESCRIPTION OF EXAMPLE EMBODIMENTS

### General Encoder

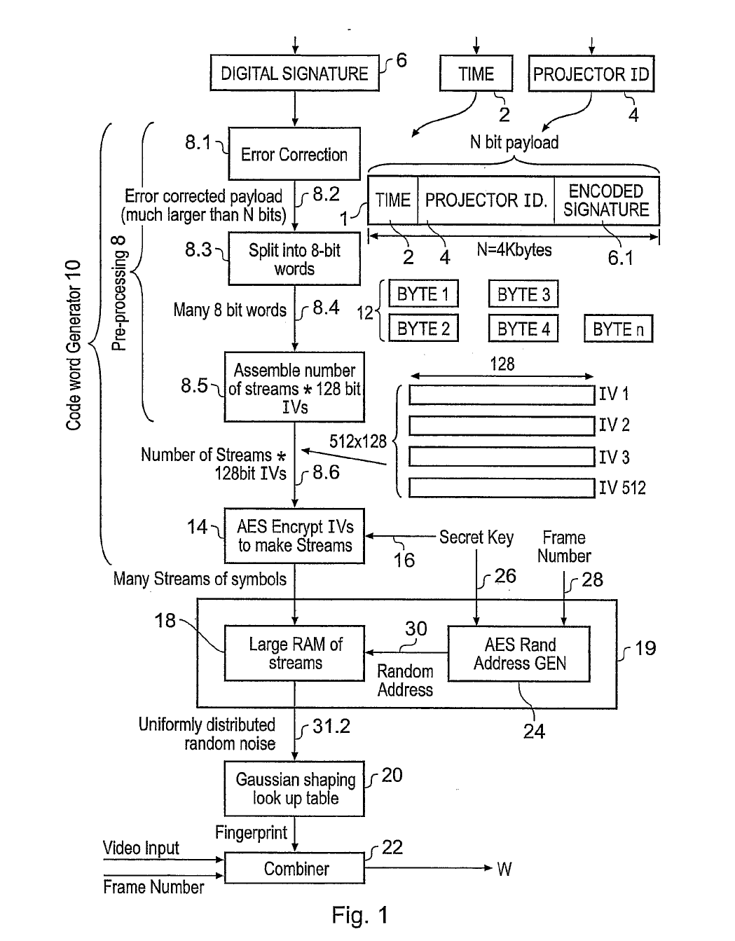

An encoding data processing apparatus according to an example embodiment of the present technique is shown in FIG. 1. FIG. 1 illustrates an example application of the present technique, in which the information material to which data is embedded is video material. In FIG. 1 a payload data word 1 includes a field indicating a time of generation of the payload 2, a projector identifier 4 and a digital signature field 6, which is to be embedded for example by a video projector into a video signal comprising a plurality of video frames. The payload data word 1 may be as long as 4 kbits. The digital signature 6 is passed through an error correction encoder 8.1, which forms an error correction encoded digital signature 6.1, which is combined with the time data 2 and the projector identifier 4 to form a payload data word 1 comprising N-bits. The N-bit payload data word is then fed on a channel 8.2 to a data word splitter 8.2, which is arranged to split the N-bit data word into each of a plurality of 8-bit bytes 12. As shown in FIG. 1 there are n-bytes 12. The bytes 12 are then passed via a connecting channel 8.4 to an initial value former 8.5, which forms a number of initial values for use in generating encrypted data streams. Each of the data streams is formed from an initial value. In one example each initial value is 128-bits in length.

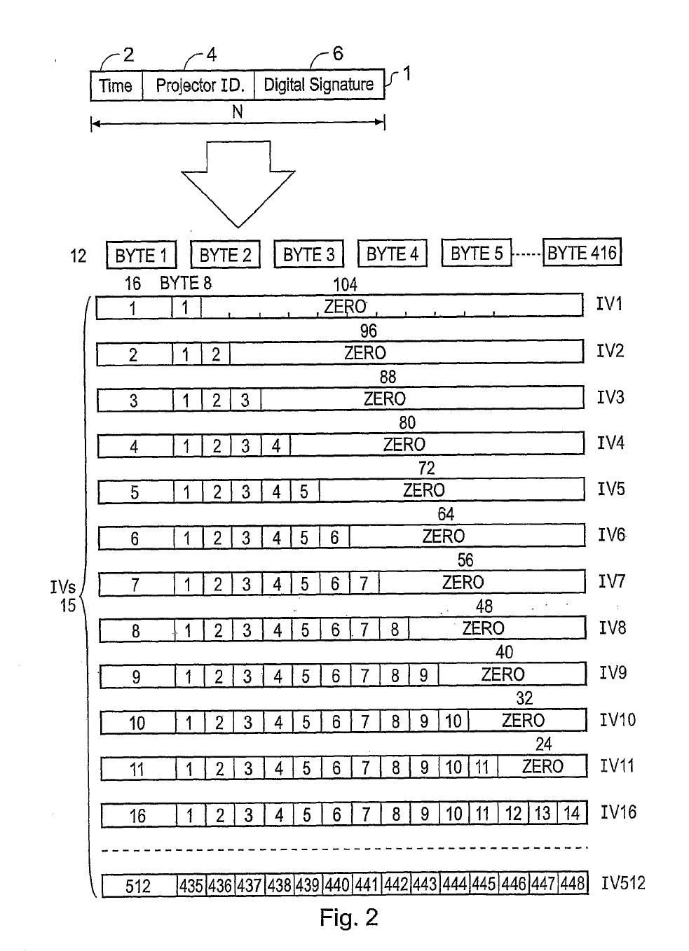

In the present example shown in FIG. 1, 512 initial values are formed, which are used to form 512 streams. Thus, at the output of the initial value former 8.5 on a connecting channel 8.6 there is provided 512×128 bit initial values from which will be formed 512 different encrypted data streams providing a water mark code word for embedding. The formation of the initial values, from which encrypted data streams are formed, will be described in more detail shortly with reference to FIG. 2.

In FIG. 1 each of the initial values is received by an encryption processor 14 which also receives a payload key via an input channel 16. The encryption processor 14 may be an AES encryption processor encrypting the initial values in accordance with an encryption algorithm known as “Rijndael” encryption. The encryption processor 14 receives each of the 128 bit initial values and generates for each initial value an encrypted data stream comprising 512 8-bit coefficients. This is done by feeding back an output from the encryption processor 14 to the input repeatedly a number of times in order to produce, for each encrypted data stream 512×8-bit coefficients. In one example there are 512 encrypted data streams, so that the water mark code word is formed from 512×512 8-bit coefficients, which represents the N-bit payload data word. The error correction encoder 8.1, the data word splitter 8.3, the initial value former 8.5 and the encryption processor 14 together form a code word generator 10. The encrypted data streams are then stored in a shuffle data store 18, which forms part of a shuffle processor 19. The encrypted data streams are read out in blocks of 8-bit words from the shuffle data store 18, which are passed to a Gaussian shaping look up table processor 20 before being combined with a frame of the video signal by a combiner 22 to form at the output of the combiner a watermarked video signal W. The combiner is arranged in one example to add the coefficients of the water mark code word to corresponding samples of the video material item.

Returning to the shuffle data store 18, according to the present technique, the shuffle processor 19 is arranged to read out the water mark code word formed from the encrypted data streams substantially randomly for embedding in the frames of the video material. To this end, an address of the shuffle data store 18 for reading out the encrypted data stream is generated by a random address generator 24. The random address generator 24 generates for each frame of the video input signal a random address, which selects randomly parts of the 512 encrypted initial values. In one example, the random address generator 24 is arranged to generate the address using an encryption algorithm, so that not only is the address generated randomly, but the address is generated in a way which does not allow a pattern of the addresses generated to be easily identified.

For the example shown in FIG. 1, the address generator 24 receives the same payload encryption key on an input channel 26 as the encryption processor 14 received on the input channel 16. The random address generator 24 also receives a frame number of the input video signal on an input channel 28. Thus by generating addresses randomly within the address space of the encrypted shuffle data store 18 as produced at an output 30 of the encrypted random address generator 24, parts of the streams maybe read out of the shuffle data store 18 and passed through the Gaussian shaping look up table before being combined with a frame of the video material by the combiner 22.

The shuffle data store 18 is arranged to store the encrypted data streams and the shuffle processor 19 is arranged to shuffle the streams for embedding into the video image frames. In one example, a fraction of the content of the data store is randomly selected and embedded into each frame of the video signal. For example, for each of 512×128-bit initial values, a 512×8-bit encrypted stream is produced. Thus the shuffle data store is arranged to store 512×512×8-bit bytes, which is 262144 bytes. The shuffle processor 19 is operable to read out ⅛-th of the shuffle data store for each frame, which is 32678 bytes, so that the combiner 22 can embed the 32678 bytes in each frame.

In accordance with the present technique because the encryption data streams are read out randomly from the shuffle data store 18 and embedded in a corresponding frame of the video material, a likelihood of an attacker determining and identifying a particular input data stream from the watermarked video signal is substantially reduced. Furthermore, passing the encrypted data streams through a Gaussian look-up table, has an effect of making the encrypted data streams appear more noise like and therefore less likely to be detected.

### Formation of the Initial Values

As will be explained shortly, advantageously the encrypted data streams may by substantially orthogonal with the effect that the detection of one of the data streams with respect to the other data streams by correlation can be effected with reduced interference from the other data streams. A formation of the encrypted data streams will now be described in more details with reference to FIG. 2. In FIG. 2 the payload data word comprising N bits 1 is shown as received at the output of the error correction encoder 8.1 in FIG. 1. The N bit encrypted data word is then split by the data word splitter 8.3 into bytes 12. In one example there are 416 bytes which can be conveyed within the 512 encrypted data streams.

As shown in FIG. 2 each of the encrypted data streams is formed from the initial values 15 by writing bytes of the payload into each of the initial values in accordance with the formula identified above and repeated below:

IVₙ=Σₗ₌₀^{l=n-1}byte(n−l)

As shown in FIG. 2 each of the initial values includes 128 bits, 16 bits being assigned to a field index. The field index includes the number of the initial value which therefore represents the value of the data stream. As shown in FIG. 2 the first initial value IV₁ which is numbered 1 in the 16 bit field, has byte 1 with the remaining 104 bits being set to a predetermined value such as zero. In accordance with the above formula the second initial value IV₂ which is numbered 2 in the index field includes bytes 1 and 2 with the remaining 96 bits set to zero. Thus, to form the next initial value the subsequent byte is concatenated with all the previously processed bytes. The number of zeros which remain is slowly reduced down to zero in a final initial value of a first set of 16 which will be intermediate number 16. Thus, each set of IV values includes a corresponding set of bytes shown in the table below:

| Streams | Bytes of Payload |
|---|---|
| 1 to 16 | 1 to 14 |
| 17 to 32 | 15 to 28 |
| 33 to 48 | 29 to 42 |
| 49 to 64 | 43 to 56 |
| — | — |
| 496 to 512 | 435 to 448 |

Thus, as shown in FIG. 2 the final initial value number 512 will include bytes numbered 435 to 448.

As shown in FIG. 1 each of the initial values is then encrypted to form a 512×8-bit encrypted data stream, which is then read into the shuffle data store for reading out and combining with a frame of the video material. Thus in one example, each frame of the video material will include random parts of all of the encrypted data streams, the encrypted data streams being thereby effectively shuffled with respect to each frame of the video signal.

In accordance with the present technique forming the encrypted data streams from the initial values shown in FIG. 2 provides an advantage because the encrypted data streams can be made substantially orthogonal. Each of the encrypted data streams is made substantially orthogonal with respect to one another as a result of two properties, which are that firstly the streams are encrypted and secondly that the length of each of the data streams is sufficiently long to appear substantially “random-like”. Encrypting the data streams as part of their generation has an effect that a change of one bit in the initial value input to the encryption circuit has an effect of producing a very different encrypted data stream with respect to the encrypted stream, which would have been generated for the unaltered initial value. Furthermore, by arranging for the encrypted data streams to be sufficiently long, the patterns of data bits within each stream can be made to appear more random like.

According to the present technique, by forming the initial values in the way set out above, the detection of byte 1 can be used to detect byte 2. The detection of byte 1 will require only 2⁸ correlations. When detecting byte 2, a correlation can be performed for all possible values of byte 2 only, since byte 1 which is also present will then be known. The detection of byte 2 can therefore be made also with only 2⁸ correlations, so that the detection of bytes 1 and 2 will require only 2×2⁸ correlations as opposed to 2¹⁶ correlations, which can therefore be made more easily. As will be explained shortly therefore, by recovering each byte of the payload starting with the first and successively increasing the parts of the payload recovered by increasing the initial value number which is searched from 1 to 16, an amount of processing which is required in order to detect successfully all 14 bytes from the first 16 initial values is reduced to a practical level. Correspondingly the next 14 bytes from the subsequent 16 initial values can be recovered until the entire payload is recovered. For each byte to be detected by the detecting data processor only 2⁸ possible correlations are required as opposed to 2⁴⁰⁹⁶ to detect the 4096-bits of a payload data word by correlation, which could otherwise be prohibitively computationally difficult.

Since the payload data word includes a digital signature 6, if the recovered digital signature is authenticated then the payload can be considered to have been successfully recovered. It is for this reason that error correction encoding can be applied to the digital signature, whereas error correction encoding is not applied to the projector identifier (ID) or the time stamp. Adding error correction to the projector ID and the time stamp may compromise the integrity of a false positive detection probability or false negative detection probability which is established to prove the presence of the water mark payload for a finger printing system. However, since the digital signature is self authenticating, in that if the digital signature is authenticated with a corresponding private key of the digital signature private key/public key pair, then it must be the digital signature concerned, without a need to rely on the integrity of the watermarking arrangement which conveyed that code word. Therefore, error correction can be applied to the digital signature to improve a likelihood of recovering the digital signature.

### Further Example of Initial Values

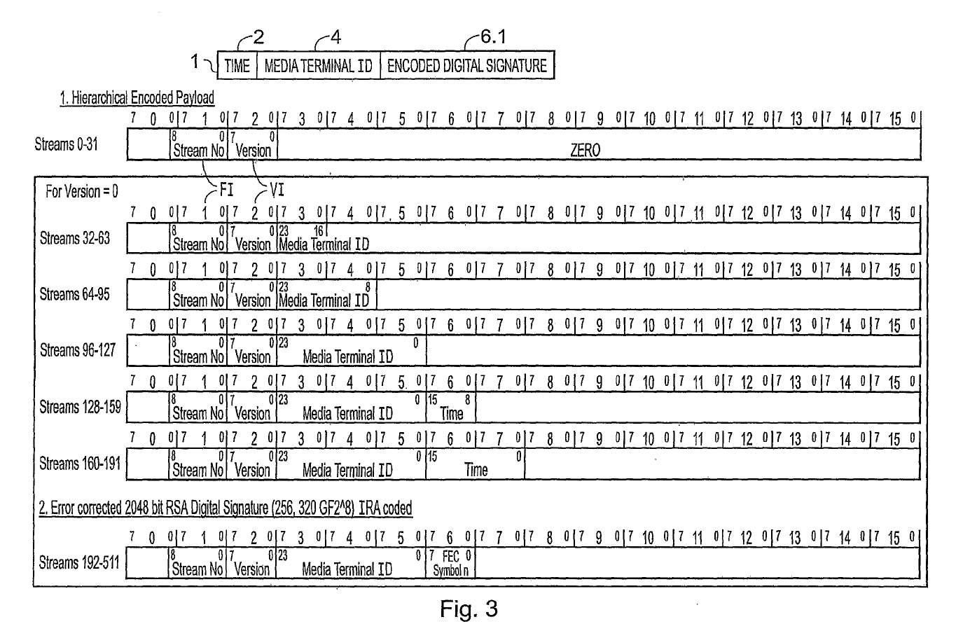

FIG. 3 provides a further example illustrating one possibility for generating the initial values for use in the encoding data processing apparatus. In FIG. 3 as for FIG. 2 there are 512 initial values for forming 512 encrypted data streams. As shown in FIG. 3 a field index for identifying the 512 encrypted data streams is provided by a nine bit data field FI to identify each of the 512 initial values for forming the encrypted streams. Since the field index FI providing a stream number comprises nine bits, a remaining seven bits of the first two bytes are set to zero or any other predetermined value, which is known at the decoder. In a third byte in each of the 512 initial values a version identifier VI is provided. The version identifier provides a byte of data indicating a version of the fingerprinting scheme which can be identified at the decoder. The decoding process can be therefore matched to the encoding process established for a particular version. Accordingly, future changes in the fingerprinting/water marking technique can be accommodated within a data structure provided by the initial value shown in FIG. 3.

In FIG. 3 the first 32 initial values providing encrypted data streams 0 to 31 are formed from the same format, that is to say as shown in FIG. 3 with only the version provided in the version identifier VI field and the remaining bytes 3 to 15 set to a predetermined value such as zero. Since all 32 streams for initial values 0 to 31 will only contain the version identifier VI, there is a greater likelihood of a decoder being able to detect the version identifier and therefore identify the correct version number for the decoder. As will be explained shortly, each of the initial values produced by streams 0 to 31 will produce a different encrypted data stream, which will be separately detected to identify the same version number to thereby confirm the value of the version number.

In order to avoid streams 0 to 31 producing the same encrypted data stream which is added to the video material items, the stream number is provided in the field index FI, which is changed to identify each of the initial values. As a result since each initial value will have a different stream number, a result of passing the initial value through an encryption circuit will produce a different encrypted data stream. Thus, each of the resulting encrypted streams produced by the initial values 0 to 31 will produce different encrypted data streams, which can thereby be more easily detected by correlation, even though each initial value otherwise conveys the same payload.

By arranging for the initial values to each be of a predetermined length and setting the predetermined length to as long as possible, an improvement is provided of a likelihood of detecting each of the encrypted data streams by correlation. This is because, whilst an encrypted data stream will correlate with itself producing a high correlation output value, the other encrypted data streams should preferably produce a low correlation output value so that as far as possible these other encrypted data streams appear as noise with respect to a wanted encrypted data stream during correlation. The unwanted encryption data streams will produce a lower correlation value for longer encrypted streams. Thus, by setting the initial values to a predetermined length which is long enough to cause a correlation with unwanted encrypted data streams to be a substantially low value, a likelihood of successfully detecting the wanted encrypted data stream is increased.

As shown in FIG. 3, after the first 32 initial values (streams 0 to 31) the next 159 initial values are arranged in a hierarchically encoded form as illustrated for the example in FIG. 2. Thus, streams 31 to 63 will include byte 1 of the media terminal ID from the data field 4 of the payload word 1. The next streams 64 to 95 will include both the first and second bytes of the media terminal ID in bytes 3 and 4 of the initial value and the next set of initial values 96 to 127 will include the three bytes of the projector ID in bytes 3, 4 and 5. Streams 128 to 159 will include the first byte of the time stamp in byte number 6 and streams 160 to 191 will include the two bytes of the time stamp in bytes 6 and 7.

In FIG. 3 although the media terminal ID is provided in bytes 3, 4 and 5 of streams 192 to 511, each byte of the encoded 2048 bit RSA digital signature is provided successively in byte 6. Thus the encoded digital signature is divided into bytes and each of those bytes is included in a different one of the streams 192 to 511. Thus, unlike the example shown in FIG. 2, a successive introduction of each of the bytes of the data stream to each of the other bytes of the data stream being included in each initial value is not adopted for the encoded digital signature.

The hierarchical encoding arrangement provided for the initial values 32 to 191 for the media terminal ID and the time stamp is provided in order to remove an ambiguity in a situation where more than one payload data word is present in a watermarked copy of a video material item. For an example in which a collusion attack has taken place in which an attacker combines two versions of the same watermarked image, each being produced from a different digital projector, detecting each byte from for example the first set of streams 31 to 63 may produce two detected bytes. If the next set of streams were to identify the second bytes of for example media terminal ID without the presence of the first byte there would be some ambiguity in the order of those two bytes within the material. In order to avoid this ambiguity the hierarchical encoding arrangement shown in FIGS. 2 and 3 for the initial values is provided. Since both bytes 1 and 2 will appear in the second set of streams 64-95 then this ambiguity is resolved because the order of these bytes can be identified from the detected data streams 64-95.

The ambiguity in the order of the detected bytes is not so relevant to detecting the digital signature. This is because since a digital signature can be uniquely identified with a corresponding key of a private key/public key pair, although there may be some ambiguity in the order of the bits, if one of these orders of the bits correctly identifies a digital signature then that digital signature will, with a very high likelihood, correctly identify the authenticity of that digital signature. As such, for the example of FIG. 3, the hierarchical encoding of the initial values is not used for encoding the digital signature.

### Further Examples of Encoders

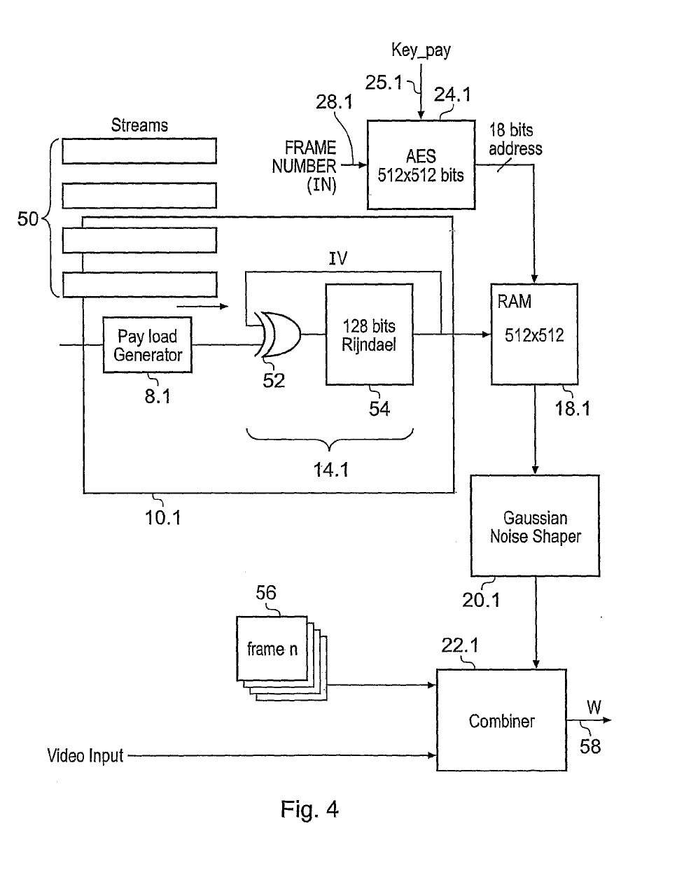

An example encoding processor in accordance with the present technique is shown in FIG. 4. In FIG. 4 the error correction encoding, the data splitting and the formation of the initial values shown in FIG. 1 are referred to as pre-processing 8 which are performed by a payload generator 8 shown in FIG. 4. Thus, in correspondence with the operation shown in FIG. 1, the payload generator 8 generates a plurality of initial values 50 which are fed to a first input of an XOR circuit 52. In FIG. 4 encryption of the 128 bit initial values is performed by a Rijndael algorithm formed by an encryption processor 54 which in combination with the XOR circuit 52 generates the encrypted data streams by feeding back the output from the Rijndael processor 54 to a second input of the XOR circuit 52. Thus, in correspondence with the encoder shown in FIG. 1, the XOR circuit 52 and the Rijndael processor 54 form an encryption data processor 14.1 and the encryption processor 14.1 and the payload generator 8 form a code word generator 10.1. By passing the 128 bit initial values thirty two times through the Rijndael encryption processor 54 and XOR circuit 52, the 512 8-bit values for each of the encrypted data streams are formed and fed into an shuffle data store 18.1. In correspondence with the arrangement shown in FIG. 1, a shuffle processor 24.1 includes a random address generator, which uses an AES algorithm processor performing the Rijndael algorithm and receives the frame number of the video input signal on an input channel 28.1 and a payload encryption key on an input channel 26.1. The shuffle processor 24.1 forms a random 18-bit address which is used to address the shuffle data store 18.1. As with the operation of the encoder shown in FIG. 1, to make the embedded data more noise like, the encrypted data stream read out from the data store 18.1 is passed through a Gaussian noise shaper 20.1 and embedded by a combiner in a frame of the video input signal 56 to produce a watermarked output video signal on an output channel 58.

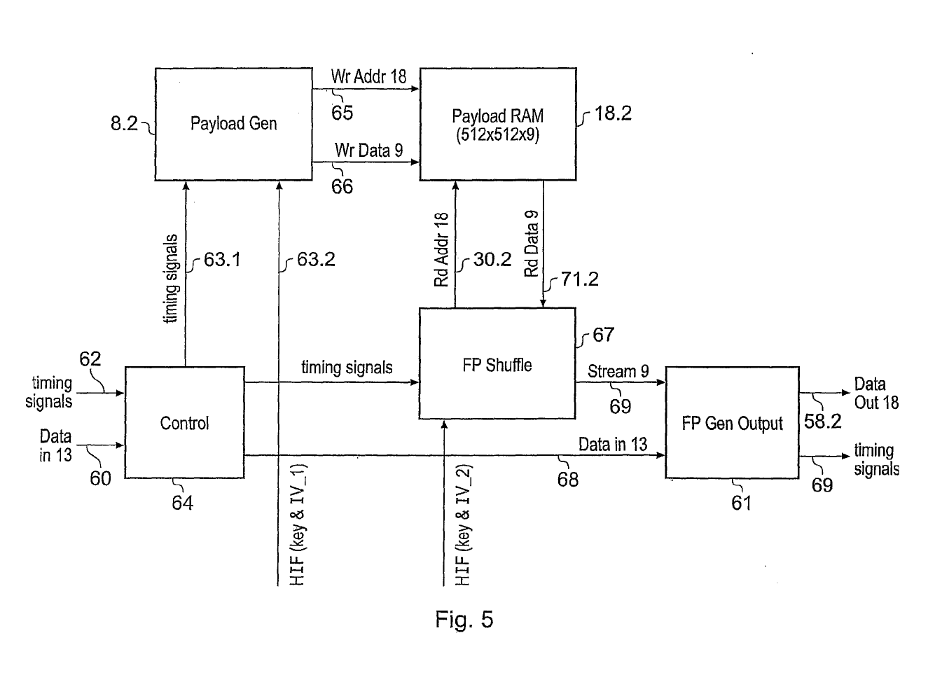

A further example encoding data processing apparatus in accordance with the present technique is shown in FIG. 5. In FIG. 5 the video input signal is received on an input channel 60 with a timing signal received on an input channel 62. A control processor 64 passes the timing signal on to a payload generator 8.2 via a channel 63.1. The payload generator 8.2 operates in accordance with the payload generator 8 shown in FIG. 1 to perform the pre-processing operations 8, shown in FIG. 1. A second input to the payload generator passes the initial values on an input channel 63.2 which are generated in accordance with the example shown in FIG. 2.

The payload generator 8.2 generates a write address on a channel 65 and writes data on a channel 66 in order to store the encrypted data streams into a “payload RAM” forming a shuffle data store 18.2. A finger print shuffle processor 67 generates a random address using a random address generation processor such as that shown in FIGS. 1 and 3, and feeds the random address on a channel 30.2 to the shuffle data store 18.2 and reads out the data on a connecting channel 31.2. Thus, the finger print shuffle processor 67 provides parts of the water mark code word formed from the encrypted data streams or parts thereof to be combined with a corresponding frame of the video input signal. Before being combined with the video frame, the parts of the encrypted data streams are passed through an output generator 61, which forms at an output 58.2 the water mark code word for embedding in video frames W, using the timing signals are also output on a channel 69.

### Payload Generator

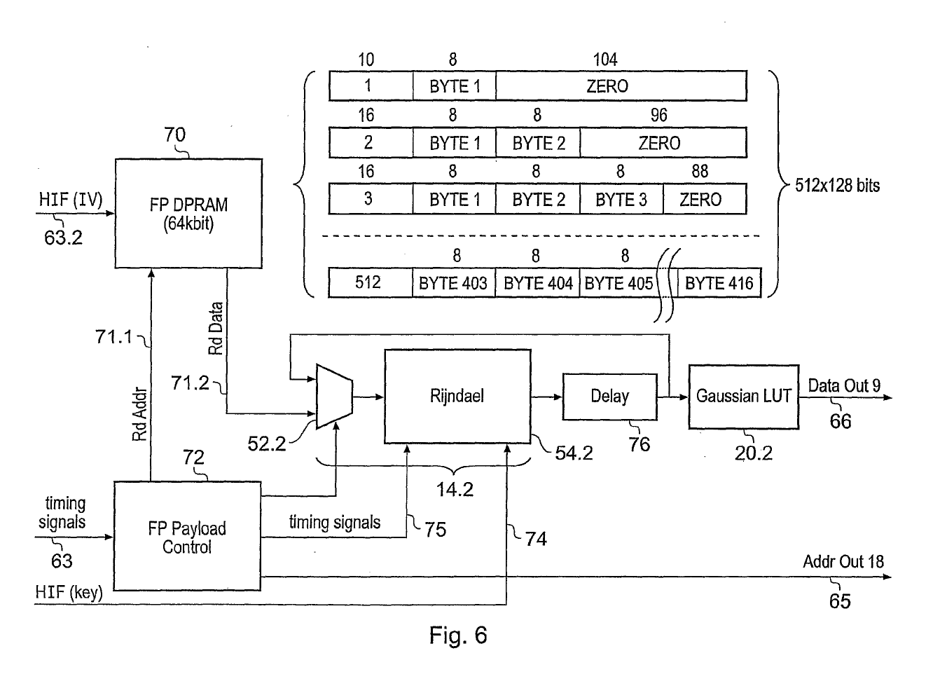

An example of payload generator 8.2, which forms part of the example encoder shown in FIG. 5, is shown in FIG. 6. In FIG. 6 the initial values are received on the input channel 63.2 at a finger print memory 70, which receives on a first input 71.1 a read address and outputs on an output 71.2 an initial value for encryption to form a corresponding encrypted data stream. The timing signals received on the input channel 63 are passed to a frame processing payload control 72 which generates the write address for writing the generated encryption stream into the shuffle data store 18.2. The write address is generated on the output channel 65 and the encrypted stream is output on the output channel 66. The payload key is received by a Rijndael processor 73 on an input channel 74 in accordance with timing signals provided on an input channel 75 from the frame processing payload control circuit 72. The Rijndael processor 54.2 in combination with the XOR circuit 52.2 encrypts the initial values in accordance with the operation of the example encoder shown in FIG. 4, under control of the finger print payload control processor 72. A delay circuit 76 is provided in order to ensure that the initial values are correctly processed by the Rijndael processor 54.2. Finally, the encrypted data stream is passed through a Gaussian shaper 20.2, which operates in accordance with the Gaussian shaping processors 20 and 20.1 shown in the embodiments in FIGS. 1 and 3.

As shown in FIG. 6 the initial values which are stored in the finger print memory 70 are read out in accordance with the addresses generated by the finger print controller 72 to be fed through the Rijndael encryption apparatus formed by the XOR circuit 52.2, the Rijndael processor 54.2 and the delay 76, and output on the channel 66 after passing through the Gaussian shaper 20.2.

### Finger Print Shuffle Processor

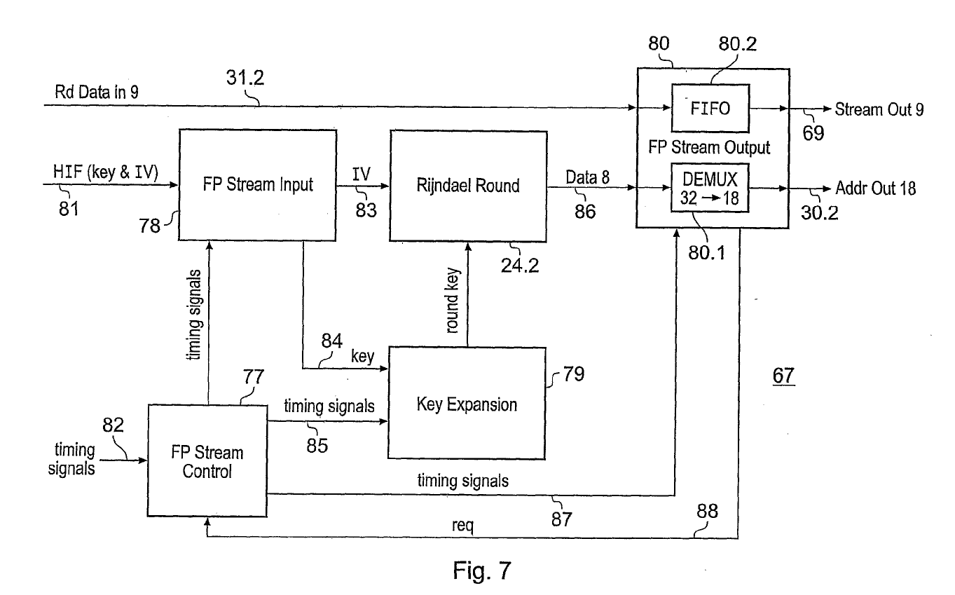

An example of the finger print shuffle processor 67, which appears in FIG. 5, is shown in FIG. 7. The finger print shuffle processor 67 performs a corresponding function to that of the shuffle processors 24, 24.1 shown in FIGS. 1 and 3. The finger print shuffle processor includes a finger print stream control unit 77, a finger print stream input 78, a Rijndael processor 24.2, a key expansion unit 79 and a finger print stream output unit 80. The finger print shuffle processor 67 receives the payload key and an initial value for forming the random address using the Rijndael round encryption processor 24.2 on an input channel 81. Timing signals are received by the frame processing stream control unit 77 via an input channel 82. The key and initial values received on the input channel 81 are split by the frame processing stream input unit 78 into an initial value which is passed on a channel 83 to the Rijndael processor 24.2 and a key which is passed via channel 84 to a key expansion unit 79. In accordance with the timing signals received via a channel 85 a key is extracted and passed to the Rijndael round processor 24.2, which generates a random address. The output of the Rijndael round processor 24.2 is a random address which is received at a finger print stream out processor 80 via a channel 86 for outputting as an 18-bit address on the output channel 30.2. A 32-to-18 bit de-multiplexer converts a 32-bit address provided by the Rijndael round processor 24.2 into an 18 bit address for output on the connecting channel 30.2. A FIFO buffer 80.2 buffers each encrypted data stream read out from the encrypted stream store 18.2, shown in FIG. 5, via channel 31.2 to be output from the finger print shuffle processor via the output channel 69. Control and timing is made using timing signals received from the finger print stream control processor 77 on a channel 87 and a corresponding feedback request signal 88 fed back to the finger print stream control processor 77.

### Perceptibility Weighting Combiner

Co-pending UK patent application 0424225.1 discloses a technique for weighting coefficients of a water mark or digital finger print code word in accordance with a relative ability of a corresponding part or pixel of an image frame to which the code word is being added, to carry that coefficient without introducing a viewer perceivable effect on the image. A perceptual weighting factor generator for generating the weighting factors for weighting the 8-bit values from the encrypted data streams is not shown in the Figures. An example of such a perceptual weighting generator is provided in the abovementioned UK patent application 0424225.1.

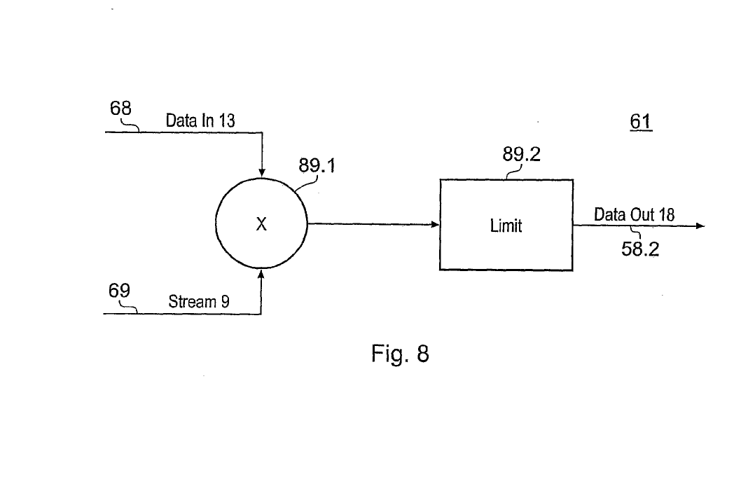

An example of the finger print output generator 61, shown in FIG. 5, is provided in FIG. 8. In FIG. 8, the perceptual weighting factors, which have been derived for the video image frame are fed via the input channel 68 to a multiplier 89.1 for multiplication with a corresponding one of the 512 8-bit coefficients of a value of the encrypted data stream, before being limited by a hard limiter 89.2 to form at the output 58.2 water marked coefficients for combining with the samples of the video signal. The output coefficients from the channel 58.2 are combined with the samples of the video signal by addition, which is not shown for this example, but would otherwise be formed by the combiner 22.1 shown in FIG. 4 or the combiner 22 shown in FIG. 1.

The term “samples” is used to refer to discrete samples from which an image is comprised. The samples may be luminance samples of the image, which are otherwise produced from the image pixels. Therefore, where appropriate the term samples and pixels are inter-changeable.

### Detecting Processor

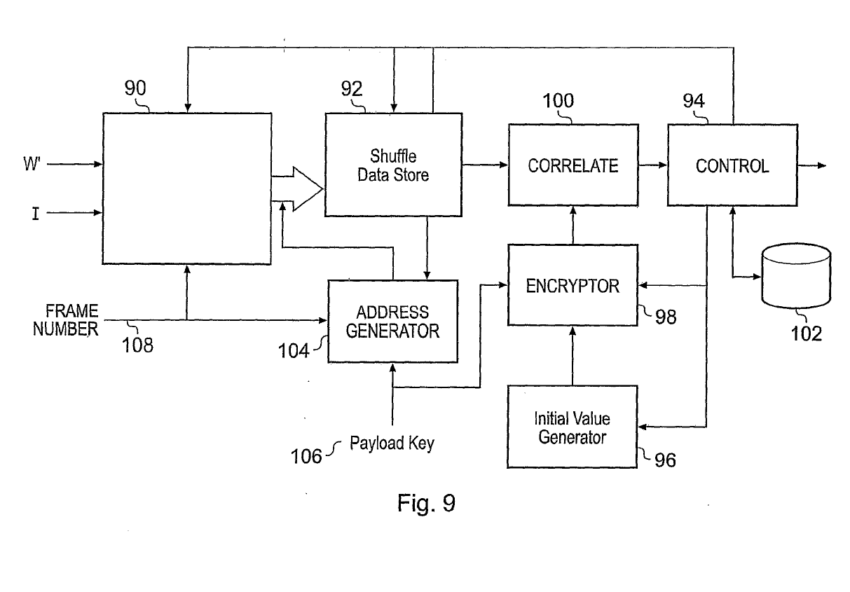

A detecting data processing apparatus, which is arranged to detect code words, which have been embedded in video material items by the encoding data processing apparatus of FIGS. 1 to 8 and to recover the payload data word if present in the video material item is shown in FIG. 9. In FIG. 9 an offending version of the watermarked image W′ and a copy of the original image I are received in a recovery processor 90. The recovery processor 90 is arranged to process the marked image W′ and the original image/and to form an estimate of a code word which may have been embedded in the marked image. For the example, after registering the water marked image W′ with the copy of the original image I, the original image I is subtracted from the watermarked image W′ to form an estimate of the parts of the code word, which are parts of the encrypted data streams, which have been recovered from the frames of the water marked video image W′. The recovered data streams are then read into a shuffle date store 92.

The detecting data processing apparatus shown in FIG. 9 includes an address generator 104, which is operable in combination with the shuffle data store to re-assemble the water mark code word, by reading the respective parts of each of the encrypted data streams from which the code word is comprised into the data store in a corresponding way to which the shuffle processor 19, 18.1, 24.1, 67 read data out of the shuffle data store in the encoding data processing apparatus. To this end, the address generator uses the payload encryption key 106 and the frame number of the water marked video image 108 to generate, pseudo randomly, at least one address within an address space of a shuffle 92 data store for each of the video frames. The address generator 104 then reads the data representing the estimate of the part or parts of the water mark code word provided from the recovery processor 90 into the shuffle data 92 at locations identified by the pseudo randomly generated address. The address generator is thereby arranged to generate the same address for each frame as those generated by the encoding data processing apparatus, so as to effectively reverse the shuffling performed by the shuffle processor 19, 67.

As mentioned above, in order to recover the payload data word, the detector shown in FIG. 9 is arranged to re-generate the encrypted data streams and to correlate the encrypted data streams with the recovered data streams read out from the data store 92. To this end, a controller 94 is arranged to regenerate all possible values of each byte of the payload which is being detected using an initial value regenerator 96. The initial value regenerator 96 produces for each of the possible values of the bytes concerned, an initial value in a form corresponding to that shown in FIG. 2 or FIG. 3 as appropriate. The initial values for each byte being detected are then encrypted by an encryption processor 98, which operates to form corresponding encrypted data streams using an encryption algorithm and the payload encryption key, corresponding to that used in the encryption processor 14, 14.1, 14.2. The encrypted data streams are then fed to a correlator 100, which correlates each of the encrypted data streams with the recovered data streams. If a result of any of the correlations exceeds a pre-determined threshold, then the value of the byte or any other parts of the payload, which were used to form the corresponding initial value is determined to be present in the payload data word which has been embedded into the video material. The value of this byte may then be stored in a detected payload data store 102.

The presence of zeros or indeed any other default value which is used by the encoder and known to the decoder for parts of the initial values which do not contain parts of the payload data word can have an effect of improving the orthogonality of the encrypted data streams with respect to one another.

As indicated above, the detection of one part of the payload data word can be used to detect other parts of the payload data word. For example, starting with the first initial value identified by the index field having a value of 1, the first byte 1 can be detected using 2⁸ re-generated encrypted data streams and corresponding correlations. The detection of byte 1 can be used to detect byte 2, because all possible values of byte 2 can be combined with the value from byte 1 read out from the recovered payload data store 102. As a result, a number of correlations which is required to detect the payload data word can be substantially reduced with respect to what would be required if a correlation was being made for all possible values of the payload alone. This is because each byte of the payload is recovered starting with the first and successively increasing the parts of the payload recovered by increasing the initial value number which is searched from 1 to 16, in order to recover the 14 bytes from the first 16 initial values. Correspondingly the next 14 bytes from the subsequent 16 initial values can be recovered using the same process until the entire payload is recovered.

As mentioned above, in one example, the initial values used by the encoding data processing apparatus to form the encrypted data stream include a field index identifying each of the encryption data streams with respect to the others. For this example, the initial value regenerator is operable to re-generate the initial values for the part of the payload data word being detected using a corresponding field index value in order to produce exactly the encrypted stream for which correlation is being performed. Furthermore, the field index may be used to detect the subsequent part of the payload data word.

As mentioned above, the payload data word includes a digital signature 6. The other parts of the payload data word can be considered to have been successfully recovered with a false positive and false negative detection probability established for the water marking/finger printing technique described above. However, if the recovered digital signature is authenticated then the payload can be considered to have been successfully recovered, because authentication as a digital signature requires a corresponding key from a public key/private key pair. Thus combining the signature with a corresponding key from the pair will authenticate the recovery digital certificate. Furthermore, for the example shown in FIG. 2, the correlator will only need to perform 448×2⁸ correlations to detect a 4096-bit payload data word as opposed to 2⁴⁰⁹⁶ correlations, which could otherwise be prohibitively computationally difficult.

Various further aspects and features of the present invention are defined in the appended claims. Various modifications can be made to the embodiments herein before described without departing from the scope of the present invention.

As mentioned above, embodiments of the present invention find application with embedding data in any kind of information material. For example, although the above embodiments have been described with respect to representing a payload data word as a code word and embedding the code ward in the form of encrypted data streams in the frames of the video material, the present technique is also applicable to embedding data in audio material. For the example of audio material, in digital form, audio material typically comprises a plurality of data frames, in which the encrypted data streams will be embedded.

1. An encoding data processing apparatus for generating a marked copy of a material item by representing a payload data word as a code word and embedding the code word into a copy of the material item, the apparatus comprising
a code word generator including a pre-processor and an encryption processor, the pre-processor being operable
to divide the payload word into a plurality of parts,
to form a plurality of initial values from the plurality of parts, each of the initial values being formed by adding parts of the payload data word to each initial value successively starting with the first part added to the first initial value, and adding the first and second to the second initial value so that each subsequent initial value includes all the parts of the payload data word of those of the previous initial values in addition to a new part of the payload data word, and
the encryption processor being operable to receive each of the initial values and to generate an encrypted data stream from each of the initial values using a payload encryption key to provide a plurality of encrypted data streams, and
a combiner operable to select parts of the encrypted data streams, and to combine the selected parts of the encrypted data streams with the frames of the material item.

2. An encoding data processing apparatus as claimed in claim 1, wherein the pre-processor is operable to provide each initial value with a predetermined length, each having at least one part of the payload data word and the remainder of the initial value being set to a predetermined value.

3. An encoding data processing apparatus as claimed in claim 2, wherein the predetermined length of the initial values is set so that after encryption the initial values are at least partially orthogonal to the effect that when correlating for a re-generated encrypted data stream, the other encrypted data streams appear substantially noise-like.

4. An encoding data processing apparatus as claimed in claim 1, wherein if an initial value is full from a present part and all parts present in previous initial values, the next part is introduced into a next initial value without any other parts.

5. An encoding data processing apparatus as claimed in claim 1, wherein the pre-processor is operable to include a field index in each initial value, which identifies each of the initial values with respect to the other initial values.

6. An encoding data processing apparatus as claimed in claim 4, wherein the payload data word includes first data and second data, the first and second data providing different information, and the pre-processor being operable
to divide the first data of the payload word into the plurality of parts, forming the plurality of initial values from the plurality of parts of the first data, each of the initial values being formed by adding parts of the first data to each initial value successively starting with the first part added to the first initial value, and adding the first and second parts to the second initial value so that each subsequent initial value includes all the parts of the first data of those of the previous initial values in addition to a new part of the payload data word,
to divide the second data of the payload word into a plurality of parts, and
to form a further plurality of initial values by including each of the plurality of parts of the second data in a different one of the further plurality of initial values.

7. An encoding data processing apparatus as claimed in claim 6, wherein the second data of the payload data word is a digital signature.

8. An encoding data processing apparatus as claimed in claim 6, wherein the combiner is operable to select the parts of the encrypted data streams pseudo randomly, and to combine the pseudo randomly selected parts of the encrypted data streams with the frames of the material item.

9. A media terminal operable to form a marked copy of an item of material for reproduction by introducing a payload data word into a copy of the material, the media terminal comprising
a reproducing apparatus for reproducing the material item, and
an encoding data processing apparatus as claimed in claim 1.

10. A detecting data processing apparatus operable to detect a payload data word embedded within a marked copy of a material item by the encoding data processing apparatus according to claim 1, the detecting data processing apparatus comprising
an initial value regenerator operable
to generate each possible value of each of a plurality of parts of the payload data word, starting with the first part,
to form, for each possible value of the part of the payload data word an initial value,
an encryption processor being operable to receive each of the initial values and to regenerate an encrypted data stream from each of the initial values using a payload encryption key, and
a correlator operable under control of the control processor to detect the part of the payload data word by correlating each of the regenerated encrypted data streams with a part of the code word, corresponding to the encrypted data stream for the regenerated initial value, recovered from the marked version of the material item, and detecting the part of the payload from a result of the correlation, the control processor being arranged to store the detected part of the payload in a data store and to use the detected part of the payload to form subsequent initial values for the detected part of the code word in combination with all possible values of a subsequent part of the payload data word and the corresponding encrypted data streams, for detecting the subsequent part of the payload.

11. A detecting data processing apparatus as claimed in claim 10, wherein the initial values used by the encoding data processing apparatus to form the encrypted data stream include a field index identifying each of the encryption data streams with respect to the others, and the initial value regenerator is operable to re-generate the initial values for the part of the payload data word being detected using a corresponding field index value, the field index being used to detect the subsequent part of the payload data word.

12. A method of generating a marked copy of a material item by representing a payload data word as a code word and embedding the code word into a copy of the material item, the method comprising
dividing the payload word into a plurality of parts,
forming a plurality of initial values from the plurality of parts, each of the initial values being formed by adding parts of the payload data word to each initial value successively starting with the first part added to the first initial value, and adding the first and second to the second initial value so that each subsequent initial value includes all the parts of the payload data word of those of the previous initial values in addition to a new part of the payload data word until all parts of the payload data word are present in the initial values, and
generating an encrypted data stream from each of the initial values using a payload encryption key, and
combining the encrypted payload data word with the material item.

13. A method of detecting a payload data word embedded within a marked copy of a material item by the encoding data processing apparatus according to claim 12, the method comprising
generating each possible value of each of a plurality of parts of the payload data word, starting with the first part,
forming, for each possible value of the part of the payload data word an initial value,
regenerating an encrypted data stream from each of the initial values using a payload encryption key, and
detecting the part of the payload data word by correlating each of the regenerated encrypted data streams with a part of the code word, corresponding to the encrypted data stream for the regenerated initial value, recovered from the marked version of the material item,
detecting the part of the payload from a result of the correlation,
storing the detected part of the payload in a data store, and
using the detected part of the payload to form subsequent initial values for the detected part of the code word in combination with all possible values of a subsequent part of the payload data word and the corresponding encrypted data streams, for detecting the subsequent part of the payload.

14. A medium bearing data representing a marked copy material item in which a code word representing a payload data word has been embedded by the encoding data processing apparatus according to claim 1.

15. A signal representing a marked copy material item in which a code word representing a payload data word has been embedded by the encoding data processing apparatus according to claim 1.

16. Computer software having program code, which when loaded onto a data processor, causes the data processor to perform the method according to claim 12.

17. A data bearing medium bearing computer program code, which when loaded onto a data processor performs the method according to claim 12.

18. A data bearing medium according to claim 17, wherein the medium is a storage medium.

19. An apparatus for generating a marked copy of a material item by representing a payload data word as a code word and embedding the code word into a copy of the material item, the apparatus comprising
means for dividing the payload word into a plurality of parts,
means for forming a plurality of initial values from the plurality of parts, each of the initial values being formed by adding parts of the payload data word to each initial value successively starting with the first part added to the first initial value, and adding the first and second to the second initial value so that each subsequent initial value includes all the parts of the payload data word of those of the previous initial values in addition to a new part of the payload data word until all parts of the payload data word are present in the initial values, and
means for generating an encrypted data stream from each of the initial values using a payload encryption key, and
means for combining the encrypted payload data word with the material item.

20. An apparatus for detecting a payload data word embedded within a marked copy of a material item by the apparatus according to claim 19, the apparatus comprising
means for generating each possible value of each of a plurality of parts of the payload data word, starting with the first part,
means for forming, for each possible value of the part of the payload data word an initial value,
means for regenerating an encrypted data stream from each of the initial values using a payload encryption key, and
means for detecting the part of the payload data word by correlating each of the regenerated encrypted data streams with a part of the code word, corresponding to the encrypted data stream for the regenerated initial value, recovered from the marked version of the material item,
means for detecting the part of the payload from a result of the correlation,
means for storing the detected part of the payload in a data store, and
means for using the detected part of the payload to form subsequent initial values for the detected part of the code word in combination with all possible values of a subsequent part of the payload data word and the corresponding encrypted data streams, for detecting the subsequent part of the payload.

21-22. (canceled)
